(19) United States
(12) Patent Application Publication
(10) Pub. No.: US 2023/0229907 A1
(43) Pub. Date: Jul. 20, 2023

(54) SYSTEM AND METHOD FOR WATER INJECTION OPTIMIZATION IN A RESERVOIR

(71) Applicant: SAUDI ARABIAN OIL COMPANY, Dhahran (SA)

(72) Inventors: Klemens Katterbauer, Dhahran (SA); Abdulaziz Al-Qasim, Dammam (SA); Alberto F. Marsala, Venezia (IT); Abdallah Al Shehri, Dhahran (SA); Ali Yousif, Dhahran (SA)

(73) Assignee: SAUDI ARABIAN OIL COMPANY, Dhahran (SA)

(21) Appl. No.: 17/648,097

(22) Filed: Jan. 14, 2022

(51) Int. Cl. G06N 3/08

(52) U.S. Cl. CPC G06N 3/08

(57) ABSTRACT

A method for optimizing water injection in a reservoir may include obtaining a first dataset from a first pipeline system in a first reservoir, training a first model by the first dataset, and determining reliability of the first dataset by the first model. The method may include upon determining that the first dataset is reliable, generating a first categorized dataset by the first dataset and a second model, and training a third model by the first categorized dataset. The method may include optimizing water injection control parameters of a second reservoir in accordance to a final water injection scheme by the third model.

### BACKGROUND

To optimize the Injection Production ratio (IPR) of a reservoir, geoscientists and engineers must optimize the number of wells drilled, as well as the drilling and completion procedures for each well. In mature fields, the increased production from the crest necessitates drilling of up-dip injectors to support crest production. These up-dip injectors are used to increase the core pressure as well as sustaining longer production periods for wells with high water cut. Increasing number of wells requires advanced/smart completions and inflow and injection control devices (ICDs) to be deployed selectively to overcome heterogeneity, such as fractures and stratifications, and to distribute the production along the horizontal section, delaying early water breakthrough and rapid increase of water production. Smart completion includes surface to downhole sensors and related wireless accessories.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for optimizing water injection in a reservoir that includes obtaining, by a computer processor, a first dataset from a first pipeline system in a first reservoir. The method includes training, by the computer processor and the first dataset, a first model. The method includes determining, by the computer processor and the first model, reliability of the first dataset. The method includes upon determining that the first dataset is reliable, generating, by the computer processor, the first dataset, and a second model, a first categorized dataset, and training, by the computer processor and the first categorized dataset, a third model. The method further includes optimizing, by the computer processor and using the third model, water injection control parameters of a second reservoir in accordance to a final water injection scheme.

In one aspect, embodiments relate to a system for optimizing water injection in a reservoir. The system includes an optimization manager comprising a computer processor. The optimization manager obtains a first dataset from a first pipeline system in a first reservoir. The optimization manager trains a first model utilizing the first dataset. The optimization manager determines, by the first model, reliability of the first dataset. Upon determining that the first dataset is reliable, the optimization manager generates, by a second model and the first dataset, a first categorized dataset, and trains, by the first categorized dataset, a third model. The optimization manager optimizes, using the third model, water injection control parameters of a second reservoir in accordance to a final water injection scheme.

In one aspect, embodiments relate to a non-transitory computer readable medium storing instructions. The instructions obtains a first dataset from a first pipeline system in a first reservoir. The instructions train, by the first dataset, a first model. The instructions determine, by the first model, reliability of the first dataset. Upon determining that the first dataset is reliable, the instruction generate, by a second model and the first dataset, a first categorized dataset by a second model, and train, by the first categorized dataset, a third model. The instructions further optimizes, using the third model, water injection control parameters of a second reservoir in accordance to a final water injection scheme

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a reservoir system in accordance with one or more embodiments.

FIG. 2 shows a system in accordance with one or more embodiments.

FIG. 3 shows an example expanding on one or more components shown in FIG. 2.

FIG. 4 shows a workflow in accordance with one or more embodiments.

FIG. 5 shows an example of model workflows in accordance with one or more embodiments.

FIG. 6 shows a computing device in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

This disclosure provides an automatic procedure that determines optimized field water injection utilizing an artificial intelligence framework incorporating inline sensors and wireless communication. Embodiments of the disclosure also provide a workflow of constructing a plurality of models that are used in the artificial intelligence framework. The disclosure provides water injection optimization that recovers reservoir production while maintaining sustainability. Embodiments disclosed herein relate to the field water injection optimization using an artificial intelligence framework of inline sensors and wireless control.

In one or more embodiments, the framework integrates data from inline chemical sensors for the data-driven determination of phase flow measurements and optimizes the injection via communication of wireless transmitters. The inline sensors measure the chemical composition of phase fluids in the production tube, which is then utilized in order to adapt the phase measurement velocity recordings, and determine the uncertainty of the production quantities. These data are then integrated into a data-driven injection optimization framework for the optimization of water injection. In one or more embodiments, wireless data transmission based on LoRa and 5G technologies is utilized for data communication between the wells and the water injector wells in order to deal with the substantial amount of data that is retrieved from the various connected devices, and maintain operability in harsh operating conditions to avoid a single point of failure.

In general, embodiments of the disclosure include a system and a method that automatically process a plurality of data obtained from a reservoir. In particular, the obtained data are categorized and analyzed for reliability. Further, the disclosed method provide recommendations on replacing components in the system based on reliabilities of the obtained data. The obtained data also improves phase-flow determination accuracy. Moreover, the disclosed system and method utilize a plurality of models and the obtained data to predict future production of the reservoir, and to further determine an optimized water injection scheme (i.e., an optimized recovery scheme) to achieve best production while considering sustainability. Moreover, embodiments of the disclosure also relate to constructing the plurality of models. By utilizing wireless communication, disclosed system and method may determine the optimized water injection scheme based on real-time data.

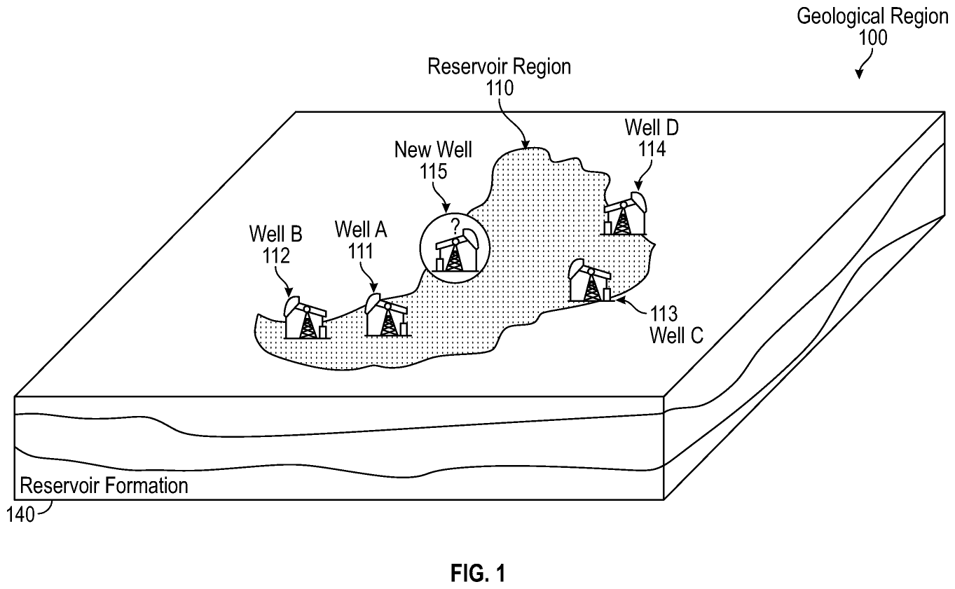

FIG. 1 shows a schematic diagram in accordance with one or more embodiments. As illustrated in FIG. 1, FIG. 1 shows a geological region (100) that may include one or more reservoir regions (110) with a plurality of wells (111-115). As shown in FIG. 1, wells A-D (111-114) and a new well E (115) are disposed above a formation (140). In alternate embodiments, the plurality of wells (111-115) may not necessarily belong to a same reservoir region, and thus, may not be adjacent wells in the same geological region, but may be distant from each other and part of different geological regions. In some embodiments, the wells (111-114) may be used as training wells from which training data are obtained. Such training data, including historical production data, inline chemical sensor data, fluid phase data, water quality data, and injection pattern data, may be obtained to train a plurality of models as further described below. Further, data obtained from the new well (115) in a new reservoir are used to predict production for the new reservoir. Particularly, in some embodiments, the wells (111-114) may be production wells and/or water injection wells, and the new well (115) may be a production well.

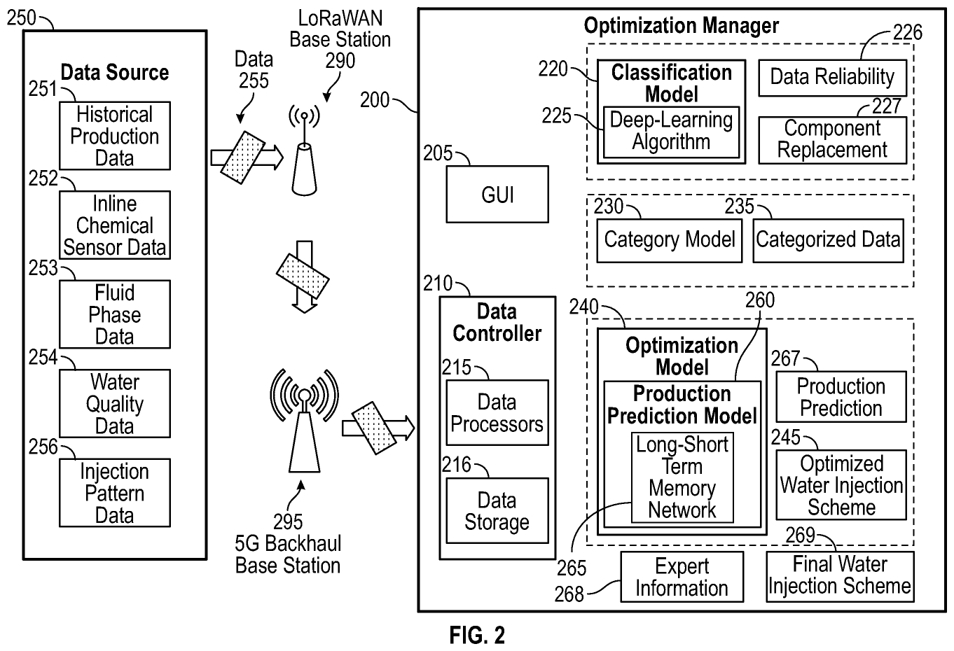

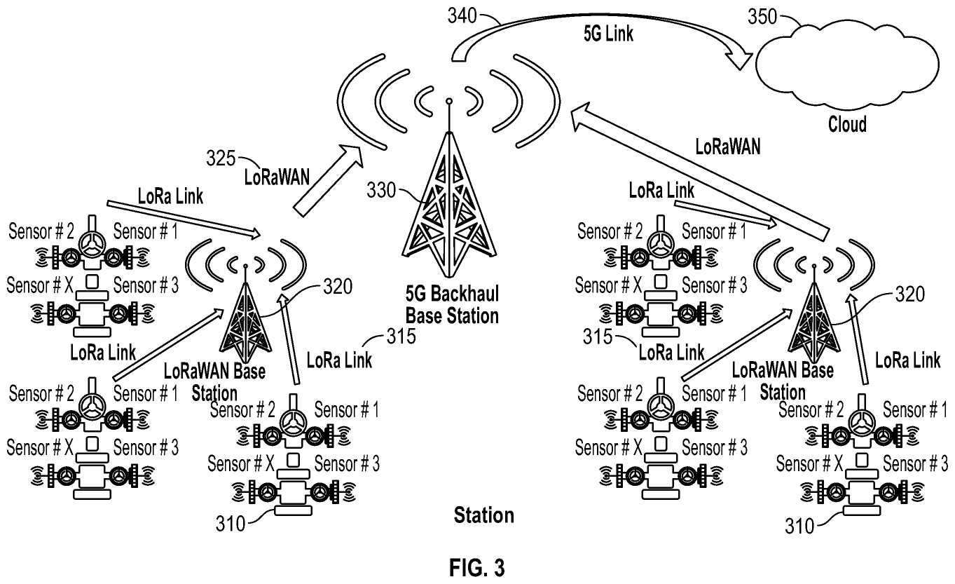

In one or more embodiments, the wells (111-114) may communication with each other and with other system components such as a optimization manager (200) utilizing 5G and LoRaWAN protocols as shown in FIGS. 2 and 3.

Turning to FIG. 2, FIG. 2 shows a block diagram of a system in accordance with one or more embodiments. As shown in FIG. 2, a data source (250) provides a plurality of data for a optimization manager (200). In some embodiments, the data source (250) may refer to any device, i.e., a camera, sensor device, etc. that obtains data from a reservoir. Further, the data source (250) may be a database located in a disk or a remote server, live measurements from physical devices such as sensors, or a(n) file/data sheet/XML file within a computer program, etc. Those skilled in the art will appreciate that the type of the data source (250) may differ according to the purposes or functions of an application. In one or more embodiments, data (255) obtained from the data source (250) may be stored on a computer, in a repository or in any other suitable data structure. In some embodiments, the data source (250) may include historical production data (251), inline chemical sensor data (252), fluid phase data (253), water quality data (254), and injection pattern data (256). In some embodiments, these data may be collected from one or more of the wells (111-115) in FIG. 1 from formation of one or more reservoirs. In some embodiments, the data source (250) may be searchable public database and/or company-owned database.

Specifically, the historical production data (251) may refer to production data that were previously measured from one or more reservoirs. In some embodiments, the historical production data (251) may include oil/water/gas rates, well pressure, choke size, and shut-in times. The inline chemical sensor data (252) may refer to data measured by inline chemical sensors deployed in a pipe system in the one or more reservoirs. More specifically, the inline chemical sensors obtain various data that reflect chemical composition of fluid flowing in the pipe system. In some embodiments, the inline chemical sensor data (252) may include, for example, pH level of the fluid, Hydrogen Sulfide (H2S) level, Carbon dioxide (CO2) level, Nitrogen oxides (NOX) level, flow rate, and gas content/temperature/pressure. The fluid phase data (253) may refer to data obtained by a plurality of multiphase flow meters (MPFMs) deployed in the pipe system. In particular, the inline chemical sensor (252) may be used to improve readings of the MPFMs. Further, in some embodiments, the water quality data (254) may include salinity content. Finally, the injection pattern data (256) may refer to established patterns for the water injection wells deployment. In some embodiments, the above-referenced various data may include existing data that have been measured from various wells in one or more tapped reservoirs, as well as real-time measured data obtained from a reservoir to be recovered.

Keeping with FIG. 2, in some embodiments, the data (255) obtained from the data source (250), particularly the real-time measured data, are transmitted to the optimization manager (200) via a wireless communication system. In some embodiments, the wireless communication system uses Long Range (LoRa) and 5G technologies to transfer the data (255) seamlessly between the data source (250) and the optimization manager (200), as well as performing additional maintenance and troubleshooting functions. The wireless communication system includes wireless LoRa-based sensors, Long Range Wide Area Network (LoRaWAN) base stations (290), 5G backhaul base stations (295), and a cloud system.

LoRa is a radio modulation technique that is based on spread-spectrum modulation techniques. LoRa mainly includes LoRa physical layer and LoRaWAN protocol. Specifically, LoRaWAN defines communication protocol and system architecture for a network while LoRa physical layer enables a long-range communication link. More specifically, LoRa utilizes a very robust wireless modulation to create a long-range communication link. In particular, for LoRa, a single gateway or base station can cover hundreds of square kilometers.

5G wireless technology is the fifth generation mobile network that delivers data with multi-Gbps peak data speeds, ultra-low latency, better reliability. 5G wireless technology provides massive network capacity and unified user experience. In addition, 5G wireless technology provides new types of network, such as Internet of Things (IoT), that are designed to virtually connect everyone and everything together including machines, objects, and devices.

FIG. 3 shows an example of the wireless communication system applied in one or more embodiments. As shown in FIG. 3, a plurality of sensors (310) communicates with a plurality of LoRaWAN base stations (320) through LoRa link. For example, the plurality of sensors (310) may comprise the inline-chemical sensors and the MPFMs, and my obtain various data, such as the historical production data (251), inline chemical sensor data (252), fluid phase data (253), water quality data (254), and injection pattern data (256), from one or more wells. The data obtained by sensors (310) are transmitted to the LoRaWAN base stations (320) through LoRa link (315). The LoRaWAN base stations (320) further communicates with at least one 5G backhaul base station (330) through LoRaWAN to transmit the obtained data. Furthermore, the 5G backhaul base station (330) communicates with and transmits the obtained data to a cloud system (350) via 5G link. In some embodiments, the cloud system (350) is coupled to the optimization manager (200) in FIG. 2. Accordingly, the one or more wells are wirelessly connected to the optimization manager (200), which allows automatic rerouting of wireless data transmission and communication in case of transmission failures, and further enables real-time transmission and reliability examination of communication channels.

Turning back to FIG. 2, the optimization manager (200) may be software and/or hardware implemented on a network, such as a network controller, and includes functionalities for determining an optimized water injection scheme to recover reservoir production. For example, the optimization manager (200) may obtain various data (255) from a reservoir through the wireless communication system, generate a plurality of models using the obtained data (255), wirelessly obtain new data from a new reservoir, and determine an optimized water injection scheme for the new reservoir utilizing the generated models. In particular, by utilizing the wireless communication system, the MPFMs and the inline chemical sensors, the optimization manager (200) is capable for auto-calibration and real-time adjustment while determining the optimized water injection scheme for the new reservoir.

In some embodiments, the optimization manager (200) may include a graphical user interface (GUI) (205) that receives instructions and/or inputs from users. More specifically, the users may enter various types of instructions and/or inputs via the GUI (205) to start certain actions, such as calculating, evaluating, selecting, and/or updating data or parameters. In addition, the users may obtain various types of results from the certain actions via the GUI (205) as outputs.

In some embodiments, the optimization manager (200) may include a data controller (e.g., data controller (210)). The data controller (210) may be software and/or hardware implemented on any suitable computing device, and may include functionalities for obtaining various data from the data source (250) and processing the obtained data (255). For example, the data controller (210) may obtain the historical production data (251), the inline chemical sensor data (252), the fluid phase data (253), the water quality data (254), and the injection pattern data (256) from the data resource (250). The data controller may include data processors (215) and data storage (216). Specifically, the data processors (215) process the data obtained from the data source (250) as well as the data stored in the data storage (216). The data storage (216) may store the various data obtained from the data source (250), and other data and parameters for the other sections and functionalities of the optimization manager (200).

Keeping with FIG. 2, the optimization manager (200) may include a classification model (220) that utilizes at least one deep-learning (DL) algorithm (225) to determine reliability (226) of the data obtained from the data source (250) and generate recommendations on component replacement (227) based on the data reliability determinations. The data reliability (226) reflects measurement accuracy of the data. Specifically, the classification model (220) may be one or more machine learning (ML) models trained by the at least one DL algorithm (225). In order to train the classification model (220), the plurality of data obtained from the data source (250) and their corresponding reliability determinations are taken as inputs, the classification model (220) is trained to correlate the plurality of data with the reliability determinations using the at least one DL algorithm (225). For example, the initial reliability determinations may be obtained via lab experimental data, as well as available field trial data. Additionally, the classification model (220) may be re-trained as more training data becomes available.

In one or more embodiments, the deep learning algorithms used to train the classification model (220) may be, for example, convolutional neural networks, deep neural networks, recurrent neural networks, support vector machines, decision trees, inductive learning models, deductive learning models, supervised learning models, unsupervised learning models, reinforcement learning models, etc. In some embodiments, two or more different types of machine-learning models are integrated into a single machine-learning architecture, e.g., an ML model may include decision trees and neural networks. In some embodiments, the optimization manager (200) may generate augmented or synthetic data to produce a large amount of interpreted data for training a particular model. More specifically, supervised ML models include classification, regression models, etc. Unsupervised ML models include, for example, clustering models. DL algorithms are a part of ML algorithms based on artificial neural networks with representation learning. For example, the DL algorithm may run data through multiple layers of neural network algorithms, each of which passes a simplified representation of the data to the next layer. More specifically, with respect to neural networks, for example, a neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning (ML), a neural network may determine which data inputs should receive greater priority in determining one or more specified outputs of the neural network. Likewise, these weighted data inputs may be summed such that this sum is communicated through a neuron's activation function to other hidden layers within the neural network. As such, the activation function may determine whether and to what extent an output of a neuron progresses to other neurons where the output may be weighted again for use as an input to the next hidden layer.

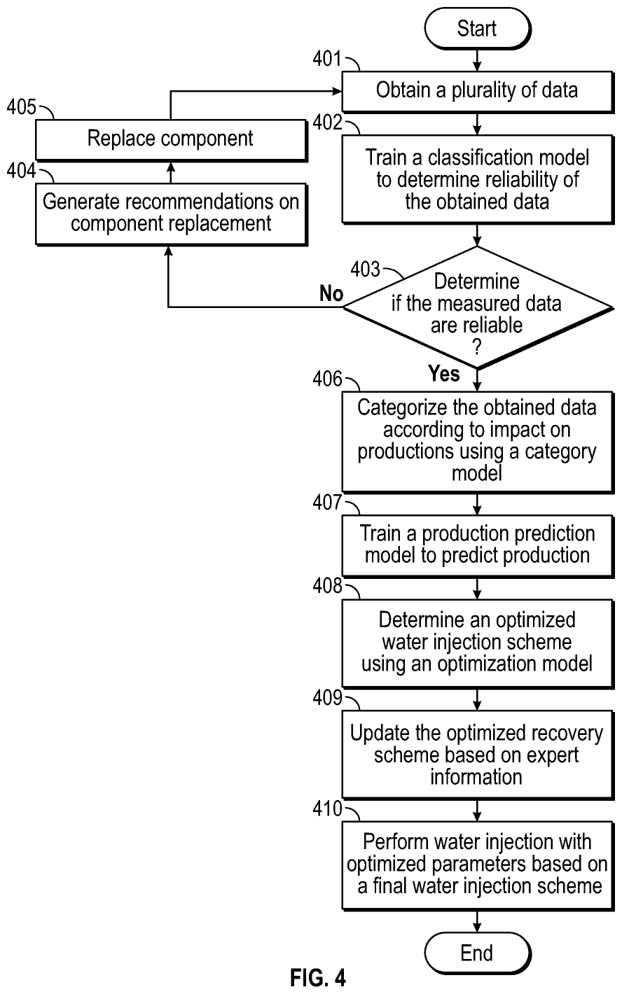

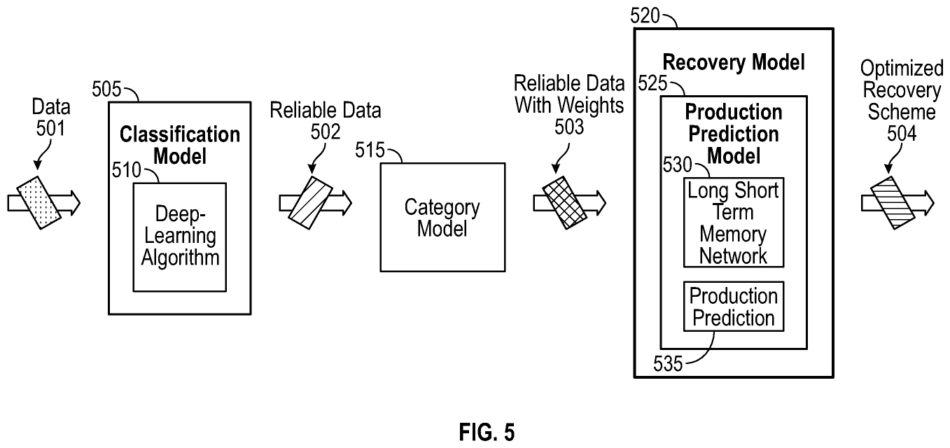

In some embodiments, the trained classification model (220) is further used to determine whether a plurality of new data should be classified as reliable or unreliable. The classification results are output as data reliability (226). The plurality of new data may be real-time data collected from the new reservoir. Data that are determined as reliable will be further used to construct and train other models, such as a production prediction model (260). Data that are determined as unreliable will not be further adopted and would result in generating the recommendations to replace corresponding components and/or devices (227), such as the inline chemical sensors and the MPFMs. More details of the classification model (220) and the deep-learning algorithm(s) (225) are explained below in FIGS. 4 and 5 and the accompanying description.

In some embodiments, the optimization manager (200) may include a category model (230) that categorizes the obtained data into a plurality of categorized data (235) based on their impact on reservoir production. In some embodiments, the obtained data (225) are clustered with weight values in 10 categories ranging from 1 to 10, wherein weight value of 1 has the least impact on production forecasts, and weight value of 10 has the most impact on production forecasts. For example, compared to injection water quantity, water salinity has a lower impact on production prediction. As such, the water salinity may have a weight value of 2 and the injection water quantity may have a weight value of 10. More details of the category model (230) are explained below in FIG. 4 and the accompanying description.

Further, in some embodiments, the optimization manager (200) may include the production prediction model (260). In some embodiments, the production prediction model (260) utilizes one or more deep-learning algorithms to generate production prediction (267) of a reservoir, such as the new reservoir. More specifically, the production prediction (267) is a numerical value that can be represented by a rate or a cumulative production.

In some embodiments, the production prediction model (260) is one or more ML models trained by Long-Short Tern Memory Network (LSTM) (265). LSTM is an artificial recurrent neural network architecture used in deep learning, which is capable of learning order dependence in sequence prediction problems. With regard to LSTM networks, an LSTM cell may include various output lines that carry vectors of information, e.g., from the output of one LSTM cell to the input of another LSTM cell. Thus, an LSTM cell may include multiple hidden layers as well as various pointwise operation units that perform computations such as vector addition. Furthermore, the size of the LSTM network may depend on the specific application. For simple geological layers, a limited number of hidden layers may be needed. For complex geological structures, a large number of hidden layers may be used to deal with the varying settings and complexity of the reservoir. To train the production prediction model (260), a plurality of water injection patterns and their corresponding production predictions for a reservoir are taken as inputs, and the production prediction model (260) is trained to correlate the plurality of water injection patterns with the production predictions using LSTM. More specifically, the water injection pattern refers to a flooding pattern for a particular arrangement of production and injection wells. For example, water injection pattern may include injection patterns within the same well or multiple wells. More specifically, in one or more embodiments, the water injection pattern may include alternate injections between the laterals either manually or autonomously via inflow control devices (ICDs) and inflow control valves (ICVs). In another example, it may include alternate injection of different types of water, such as low salinity water, medium salinity water, and sea water. For example the water injection pattern may be a direct line drive pattern, a staggered line drive pattern, a regular five-spot pattern, a regular or inverted seven spot pattern, a peripheral flood pattern, etc.

Further, the optimization manager (200) may include an optimization model (240) that integrates the trained production prediction model (260) to determine an optimized water injection scheme (245) of the reservoir. In some embodiments, the optimized water injection scheme (245) results in minimum overall carbon footprint produced during water injection process that recovers the reservoir. In particular, the optimized water injection scheme indicates water injection rate, time duration, and choke size for each individual injection well. These indicated parameters may be referred as water injection control parameters. In some embodiments, the optimized water injection scheme (245) may be further modified by users based on expert information. The expert information refers to information provided by the users to modify the optimized recovery scheme in order to adapt certain well parameters. Details of the production prediction model (260) and the optimization model (240) are explained below in FIGS. 4 and 5 and the accompanying description.

Keeping with FIG. 2, in some embodiments, the optimized water injection scheme (245) may be further adjusted based on expert information (268). Expert information (268) refers to information, such as certain requirements on parameters or outputs, that is provided by the users. In some embodiments, the expert information (268) may include known water channels between two wells, which allow observations of water production from injected wells. By taking the expert information (268) into consideration, the optimized water injection scheme (245) may be adjusted and potentially lead to suboptimal results but enables the users to adapt to the certain requirements that are not captured in the obtained data. In some embodiments, the expert information may be entered by the used via the GUI (205). The optimized water injection scheme adjusted based on the expert information (268) are determined and output as final water injection scheme (269). Expert information is information provided by the user, based on a desire to adapt certain well parameters, to modify the injection control parameters (e.g., water injection rate, time duration, choke size for each individual injection well). Necessarily, this may lead to potentially suboptimal results but enables the operator to adapt to requirements that are not captured in the data.

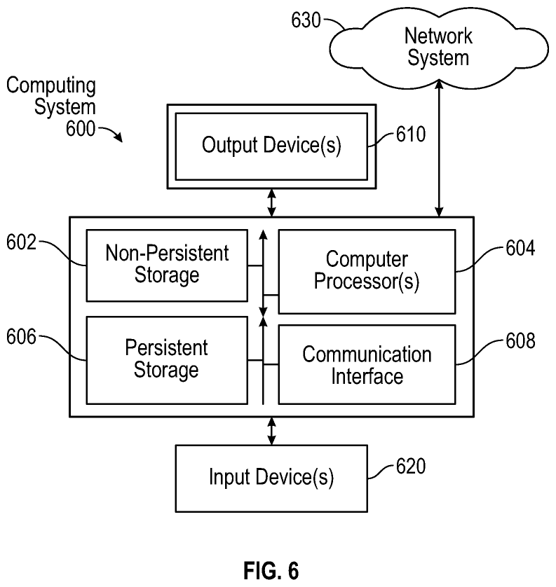

In some embodiments, the data source (250) and the optimization manager (200) may be implemented on different computing systems connected by a network. In some embodiments, the data source (250), the optimization manager (200) and/or other elements, including but not limited to network elements, user equipment, user devices, servers, and/or network storage devices may be implemented on computing systems similar to the computing system (600) shown and described in FIG. 6 below.

While FIG. 2 shows various configurations of components, other configurations may be used without departing from the scope of the disclosure. For example, various components in FIG. 2 may be combined to create a single component. As another example, the functionality performed by a single component may be performed by two or more components.

Turning to FIG. 4, FIG. 4 shows an overall workflow in accordance with one or more embodiments. Specifically, FIG. 4 describes a general workflow for an automatic procedure that obtains a plurality of data, generates a plurality of models, and determines an optimized water injection scheme for a reservoir using the plurality of data and models. One or more steps in FIG. 4 may be performed by one or more components as described in FIG. 2, for example, the optimization manager (200) which may execute on any suitable computing device, such as the computer system shown in FIG. 6. While the various steps in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Step 401, a plurality of data are obtained from a data source. For example, the plurality of data may include to the historical production data (251), the inline chemical sensor data (252), the fluid phase data (253), the water quality data (254), and the injection pattern data (256) from one or more wells, which are further obtained by the data controller (220) from the data resource (250) as illustrated in FIGS. 1 and 2. The plurality of data may also include a set of new data obtained from a new reservoir. These plurality of data are then integrated into a data-driven injection optimization framework, such as the framework of FIG. 2, for the water injection optimization.

Within the framework, in Step 402, a classification model is trained that is further used to determine reliability of the obtained data. In some embodiments, the classification model is one or more ML models trained by one or more DL algorithms and the plurality of data obtained at Step 401. The trained classification model determines reliability of the set of new data from the new reservoir. For example, the classification model and reliability determination may refer to the classification model (220) and the data reliability (226) in FIG. 2, respectively.

In Step 403, reliability of the new data are determined by the trained classification model from Step 401. Upon determining that the data are not reliable, the workflow goes to Step 404, wherein recommendations on component replacement are generated. For example, the recommendations on component replacement may be the component replacement (227) generated by the data processor (215) and conveyed to users via the GUI (205) in FIG. 2.

In Step 405, upon receipt of the recommendations, users may replace corresponding component(s), such as inline chemical sensors and MFMPs, in order to obtain more accurate and reliable data from the one or more wells. Upon determining that the obtained data are reliable, the procedure goes to Step 406. Accordingly, data with high reliability are used in ML model training processes to maintain accuracy.

In Step 406, the reliable obtained data are categorized according to their impact on production forecasts by a category model. In some embodiments, the category model categorizes the obtained data with different weight values. For example, the category model and the categorized data may refer to the category model (230) and categorized data (235) in FIG. 2, respectively.

In Step 407, a production prediction model is trained to further predict production of the new reservoir. In some embodiments, the production prediction model is one or more ML models trained by LSTM and the categorized data from Step 406. The trained production prediction model predicts production of the new reservoir. For example, the production prediction model and the predicted production may refer to the production prediction model (260) and production prediction (267) in FIG. 2, respectively.

In Step 408, an optimized water injection scheme is determined using an optimization model. Specifically, the optimization model incorporates the trained production prediction model from Step 307, and determines the optimized water injection scheme of the new reservoir based on the production prediction from Step 407. In some embodiments, the optimized water injection would result in the minimum overall carbon footprint produced during the water injection process that recovers the new reservoir. For example, the optimization model and the optimized water injection scheme may refer to the optimization model (240) and the optimized water injection scheme (245) in FIG. 2, respectively.

In Step 409, the optimized water injection scheme from Step 408 is updated based on expert information. In some embodiments, the optimized water injection scheme is adjusted based on the expert information to adapt to certain requirements that are captured by the data obtained in Step 401. The updated water injection scheme is determined as final water injection scheme. For example, the expert data and the final water injection scheme may refer to the expert data (268) and the final water injection scheme (269) in FIG. 2, respectively.

In Step 410, water injection with optimized parameters is performed in accordance with the final water injection scheme from Step 409. Specifically, in order to recover production of the new reservoir, the water injection is applied. The framework optimizes water injection control parameters that are further applied to the water injection in accordance to the final water injection scheme. Similar to the description of FIG. 2, the water injection control parameters comprise water injection rate, time duration, and choke size for each individual injection well. In some embodiments, by performing the water injection with the optimized water injection control parameters, the new reservoir is recovered to its maximum recovery degree, i.e., resulting in the maximum production, while enhancing sustainability, i.e., producing minimum overall carbon footprint. The workflow ends after Step 410.

Particularly, the framework described in FIG. 4 adopts wireless communication system to obtain and transmit various data as well to transmit various outputs or results. For example, the wireless communication system may refer to the communication system described in FIG. 3. As a result, the framework is capable to automatically reroute data by wireless transmission in case of transmission failures, obtain real-time data for water injection scheme generation, and adjust components and parameters in the framework in real time.

Those skilled in the art will appreciate that the process of FIG. 4 may be repeated for any existing reservoirs as well as for any new reservoirs that need to be recovered by water injection.

Turning to FIG. 5, FIG. 5 provides an example of generating and utilizing a series of models to determine an optimized water injection scheme for a reservoir. The following example is for explanatory purposes only and not intended to limit the scope of the disclosed technology.

In FIG. 5, a learned classification model (505) may be one or more ML models trained by DL algorithm (510). Similar to the description in FIG. 4, the classification model (505) may obtain a plurality of data from existing reservoirs and/or a new reservoir as inputs. In particular, Based on these inputs and the DL algorithm (510), the classification model (505) outputs reliable data (502), which are data that are determined as accurate and reliable by the classification model (505).

The reliable data (502) are further categorized into reliable data with different weights (503) based on their impact on production predictions. Similar to the description in FIG. 4, these data (503) are further utilized by a production prediction model (525) to generate production prediction (535) for the new reservoir. The production prediction model (525) may be trained by LSTM (530). Further, a recovery model (520), which incorporates the production prediction model (525), determines an optimized water injection scheme for the new reservoir based on the production prediction (535)

While FIG. 5 shows various configurations of components, other configurations may be used without departing from the scope of the disclosure. For example, various components in FIG. 5 may be combined to create a single component. As another example, the functionality performed by a single component may be performed by two or more components.

Turning to FIG. 6, FIG. 6 shows a computing system in accordance with one or more embodiments. As shown in FIG. 6, the computing system 600 may include one or more computer processor(s) 604, non-persistent storage 602 (e.g., random access memory (RAM), cache memory, or flash memory), one or more persistent storage 606 (e.g., a hard disk), a communication interface 608 (transmitters and/or receivers) and numerous other elements and functionalities. The computer processor(s) 604 may be an integrated circuit for processing instructions. The computing system 600 may also include one or more input device(s) 620, such as a touchscreen, keyboard, mouse, microphone, touchpad, electronic pen, or any other type of input device. In some embodiments, the one or more input device(s) 620 may be the GUI (205) described in FIG. 2 and the accompanying description. Further, the computing system 600 may include one or more output device(s) 610, such as a screen (e.g., a liquid crystal display (LCD), a plasma display, or touchscreen), a printer, external storage, or any other output device. One or more of the output device(s) may be the same or different from the input device(s). The computing system 600 may be connected to a network system 630 (e.g., a local area network (LAN), a wide area network (WAN) such as the Internet, mobile network, or any other type of network) via a network interface connection (not shown). In particular, the network system 630 may be the system as shown in FIG. 3.

In one or more embodiments, for example, the input device 620 may be coupled to a receiver and a transmitter used for exchanging communication with one or more peripherals connected to the network system 630. The receiver may receive information relating to data obtained from reservoir(s) as described in FIGS. 2-5. The transmitter may relay information received by the receiver to other elements in the computing system 600. Further, the computer processor(s) 604 may be configured for performing or aiding in implementing the processes described in reference to FIGS. 2-5.

Further, one or more elements of the computing system 600 may be located at a remote location and be connected to the other elements over the network system 630. The network system 630 may be a cloud-based interface performing processing at a remote location from the well site and connected to the other elements over a network. In this case, the computing system 600 may be connected through a remote connection established using a 5G connection, such as protocols established in Release 15 and subsequent releases of the 3GPP/New Radio (NR) standards.

The computing system in FIG. 6 may implement and/or be connected to a data repository. For example, one type of data repository is a database (i.e., like databases). A database is a collection of information configured for ease of data retrieval, modification, re-organization, and deletion. In some embodiments, the databases include published/measured data relating to the method, the systems, and the devices as described in reference to FIGS. 2-5.

While FIGS. 1-6 show various configurations of components, other configurations may be used without departing from the scope of the disclosure. For example, various components in FIGS. 2 and 6 may be combined to create a single component. As another example, the functionality performed by a single component may be performed by two or more components.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A method for optimizing water injection in a reservoir, comprising:
obtaining, by a computer processor, a first dataset from a first pipeline system in a first reservoir;
training, by the computer processor and the first dataset, a first model;
determining, by the computer processor and the first model, reliability of the first dataset;
upon determining that the first dataset is reliable,
generating, by the computer processor, the first dataset, and a second model, a first categorized dataset;
training, by the computer processor and the first categorized dataset, a third model, and
optimizing, by the computer processor and using the third model, water injection control parameters of a second reservoir in accordance to a final water injection scheme,
wherein water injection utilizing the water injection control parameters is performed in the second reservoir.

2. The method of claim 1, further comprising:
obtaining, by the computer processor, a second dataset from a second pipeline system in the second reservoir;
determining, by the computer processor and the first model, reliability of the second dataset;
upon determining that the second dataset is reliable,
generating, by the computer, the second dataset, and the second model, a second categorized dataset;
generating, by the computer processor and the third model, a production prediction of the second reservoir based on the second categorized dataset;
determining, by the computer processor and the third model, an optimized water injection scheme for the second reservoir based on the production prediction; and
generating, by the computer processor, the final water injection scheme based on the optimized water injection scheme and expert information.

3. The method of claim 1,
wherein the first model is a machine-learning (ML) model that is trained by a deep-learning (DL) algorithm; and
wherein the third model is a ML model that is trained by a Long-Short Term Memory Network (LSTM).

4. The method of claim 1, wherein
upon determining that the first dataset is not reliable, generating, by the computer processor, a first recommendation on component replacement; and
upon determining that the second dataset are not reliable, generating, by the computer processor, a second recommendation on component replacement.

5. The method of claim 1, wherein the first dataset and the second dataset are obtained and transmitted to the processor via 5G wireless communication and Long Range Wide Area Network (LoRaWAN).

6. The method of claim 1,
wherein the first dataset and the second dataset each comprise historical production data, inline chemical sensor data, water quality data, fluid phase data, and injection pattern data, and
wherein the optimized water injection control parameters comprise water injection rate, time duration, and choke size for each individual injection well.

7. The method of claim 1, wherein the optimized water injection scheme results in minimum overall carbon footprint produced while recovering the second reservoir.

8. The method of claim 1, wherein the second model generates the first and second categorized dataset based on the first and second dataset's impact on the production prediction.

9. A system for optimizing water injection in a reservoir, comprising:
a computing device with a computer processor, the computing device executing an optimization manager configured to:
obtain a first dataset from a first pipeline system in a first reservoir;
training, utilizing the first dataset, a first model;
determine, by the first model, reliability of the first dataset;
upon determining that the first dataset is reliable,
generate, by a second model and the first dataset, a first categorized dataset;
training, by the first categorized dataset, a third model, and
optimizing, using the third model, water injection control parameters of a second reservoir in accordance to a final water injection scheme,
wherein water injection utilizing the water injection control parameters is performed in the second reservoir.

10. The system of claim 9, the optimization manager is further configured to:
obtain a second dataset from a second pipeline system in the second reservoir;
determine, by the first model, reliability of the second dataset;
upon determining that the second dataset is reliable,
generate, by the second model and the second dataset, a second categorized dataset;
generate, by the third model, a production prediction of the second reservoir based on the second categorized dataset;
determine, by the third model, an optimized water injection scheme for the second reservoir based on the production prediction; and
generate the final water injection scheme based on the optimized water injection scheme and expert information.

11. The system of claim 9,
wherein the first model is a machine-learning (ML) model that is trained by a deep-learning (DL) algorithm; and
wherein the third model is a ML model that is trained by a Long-Short Term Memory Network (LSTM).

12. The system of claim 9, wherein the optimization manager is further configured to:
upon determining that the first dataset is not reliable, generate a first recommendation on component replacement; and
upon determining that the second dataset are not reliable, generate a second recommendation on component replacement.

13. The system of claim 9, wherein the first dataset and the second dataset are obtained and transmitted to the processor via 5G wireless communication and Long Range Wide Area Network (LoRaWAN).

14. The system of claim 9,
wherein the first dataset and the second dataset each comprise historical production data, inline chemical sensor data, water quality data, fluid phase data, and injection pattern data, and
wherein the optimized water injection control parameters comprise water injection rate, time duration, and choke size for each individual injection well.

15. The system of claim 9, wherein the optimized water injection scheme results in minimum overall carbon footprint produced while recovering the second reservoir.

16. The system of claim 9, wherein the second model generates the first and second categorized dataset based on the first and second dataset's impact on the production prediction.

17. A non-transitory computer readable medium storing instructions executable by a computer processor, the instructions comprising functionality for:
obtaining a first dataset from a first pipeline system in a first reservoir;
training, utilizing the first dataset, a first model;
determining, by the first model, reliability of the first dataset;
upon determining that the first dataset is reliable,
generating, by a second model and the first dataset, a first categorized dataset;
training, by the first categorized dataset, a third model, and
optimizing, using the third model, water injection control parameters of a second reservoir in accordance to a final water injection scheme,
wherein water injection utilizing the water injection control parameters is performed in the second reservoir.

18. The non-transitory computer readable medium of claim 17, the instructions further comprising functionality for:
obtaining a second dataset from a second pipeline system in the second reservoir;
determining, by the first model, reliability of the second dataset;
upon determining that the second dataset is reliable,
generating, by the second model, a second categorized dataset;
generating, by the third model, a production prediction of the second reservoir based on the second categorized dataset;
determining, by the third model, an optimized water injection scheme for the second reservoir based on the production prediction; and
generating a final water injection scheme based on the optimized water injection scheme and expert information.

19. The non-transitory computer readable medium of claim 17,
wherein the first model is a machine-learning (ML) model that is trained by a deep-learning (DL) algorithm; and
wherein the third model is a ML model that is trained by a Long-Short Term Memory Network (LSTM).

20. The non-transitory computer readable medium of claim 17, wherein the instructions further comprising functionality for:
upon determining that the first dataset is not reliable, generating a first recommendation on component replacement; and
upon determining that the second dataset are not reliable, generating a second recommendation on component replacement.
